(19) United States
(12) Patent Application Publication
(10) Pub. No.: US 2008/0317083 A1
(43) Pub. Date: Dec. 25, 2008

(54) Diode Pump

(75) Inventor: Jari Ruuttu, Billnas (FI)

Correspondence Address: BIRCH STEWART KOLASCH & BIRCH, PO BOX 747, FALLS CHURCH, VA, 22040-0747, US

(73) Assignee: PICODEON LTD OY, Hilsinki (FI)

(21) Appl. No.: 11/988,676

(22) PCT Filed: Jul. 13, 2006
(86) PCT No.: PCT/FI2006/000250

§ 371 Date: Apr. 21, 2008

(30) Foreign Application Priority Data
Jul. 13, 2005 (FI) 20050747
Jul. 15, 2005 (FI) 20050758

(51) Int. Cl. H01S 3/091

(52) U.S. Cl. 372/75

(57) ABSTRACT

This invention relates to a novel diode pump and a method of manufacturing the same. An optical laser pulse beam expander, through which a laser beam is guided forward, is integrated as a part of the diode pump according to the invention. The light bars of the diode pump are preferably made from a material that is harder than silicon and that resists large amounts of power, such as from diamond, sapphire, ruby or titanium sapphire. Using a diode pump according to the invention it is possible to guide a laser beam forward without power-restricting optical transmission fibers or optical high-power connectors. The invention enables the manufacture of very high-power diode pumps and the use thereof as a part of a laser apparatus.

### FIELD OF THE INVENTION

The invention relates generally to laser radiation but more particularly to a diode pump as defined in the preamble of the independent claim concerning it. The invention also relates to a method of manufacturing a diode pump as defined in the preamble of the independent claim concerning it. The invention also relates to a laser apparatus as defined in the preamble of the independent claim concerning it. The invention also relates to a method of manufacturing a laser apparatus as defined in the preamble of the independent claim concerning it. The invention also relates to a heat-machining laser as defined in the preamble of the independent claim concerning it. The invention also relates to a cold-machining laser as defined in the preamble of the independent claim concerning it.

### STATE OF THE ART

Laser technology has advanced remarkably in recent years, and currently it is possible to produce semiconductor-based, very high efficiency laser systems, which is an absolute requirement in so-called cold ablation methods, for example.

However, the fibers of fiber lasers do not enable the transmission of high-power laser beams compressed into pulseform to the working point. They simply do not sustain the transmission of a high-power pulse. One reason to the decision to use optical fibers to transmit laser beams is that even the transmission of only one laser beam from one place to another through free airspace, by means of mirrors to the working point, as such is very-difficult and more or less impossible to apply on an industrial scale. Besides, laser beams moving in free airspace are naturally a significant industrial safety risk.

The completely fiberbased, diodepumped semiconductor-laser has a competitor, the lamppumped laser source where the laser beam also is led first to a fiber and then therefrom further to the working point. At the moment these fiberbased laser systems are the only ways to achieve laserablation-based production on an industrial scale.

The fibers of the current fiber lasers and thus the low beam power impose restrictions on what media it is possible to evaporate. Aluminium can be evaporated at a low pulse power while copper, tungsten etc., which are more difficult to evaporate, require a significantly higher pulse power. The same applies to a situation where new compounds are to be prepared using the same technology. Examples of this are the manufacture of diamonds directly from coal or the manufacture of alumina directly from oxygen and aluminium through the reaction that takes place in the vapor phase after lasering.

Besides, taking a laser beam from the laser apparatus to the working point by means of an optical fiber is the only state-of-art alternative that works.

Accordingly, the biggest obstacle to the advancement of the fiber laser technology is that an optical fiber is not able to transmit large amounts of energy without breaking or without causing substantial deterioration of the quality of the laser beam.

Since a pulse contains a certain amount of energy and the power of the pulse increases as the pulse becomes shorter, this problem is naturally the bigger the shorter the laser pulse is. The problem is obvious already at the nanosecond-pulse laser level although it does not belong to the category of so-called cold-ablation methods.

When the length of a pulse becomes even shorter so that it is femto- or even attoseconds, the problem is almost insuperable. For example, in a picosecond laser system where the pulse length is 10-15 ps, the pulse power should be equivalent to about 5 μJ of energy, per a spot of 10-30 μm, for example, according to the requirements of the current application, such as when the total output power of the laser and the repetition frequency are 100 W and 20 MHz, respectively. On the date priority of this application there is no fiber that sustains at least said 5 μJ.

In an important field of application of the fiber laser, in laser ablation, it is critical to achieve the greatest possible, optimum pulse power and pulse energy. The shorter a pulse is, the higher is the energy passing through it within a defined period of time. In the above-mentioned situation where the pulse length is 13 ps and the pulse power equals to 5 μJ of pulse energy, and when the total input power of the laser is 100 W, the power level of the pulse is in the order about 400 000 W (400 kW). As far as the applicant knows, the know-how according to the state of art of the priority date of the present application does not enable the manufacture of a fiber in which a pulse of only 200 kW would pass through at the pulse length of 13 ps and in which the pulseform would stay optimum.

If the aim is to achieve unlimited possibilities to produce material plasma from any material or materials, the pulse power level has to be freely selectable, between 200 kW and 40 MW, for example.

However, the problems related to the current fiber lasers are not restricted only to the fiber but also to the connection of separate diode pumps together by means of optical connectors to obtain a desired total output power. Such a collected beam is then led to the working point using one fiber.

Such an optical connector should sustain as much power as the optical fiber itself that takes the high-power pulse to the working point. Besides, the pulseform should maintain its optimum shape also at this laser beam transmission stage. Even the optical connectors sustaining the current power values are very expensive to manufacture, they are not reliable and they constitute a wearing part, i.e. they have to be replaced at certain intervals.

In the current fiber lasers an even amount of energy is produced in one diode pump whereas several similar diode pumps are used. The fibers to be used must be flexible, if not, the laser fiber cannot be taken to working point. The only material that can be used in the fibers is thus silicon (pure glass) which can be drawn into a fiber thin and flexible enough, typically between 10-45 μm. If a fiber made from silicon is made thicker than 150 μm, it only will bend into a very large arc. Such a fiber is no longer useful in fiber laser applications. If a fiber made from silicon is drawn 50 μm thick, for example, it loses its capability to sustain high laser pulse power levels. If harder materials are selected as the fiber material and if a thinner fiber is manufactured, the fiber will not bend at all, and it would not be possible to draw high power resistant materials into optical transmission fibers.

The light bars (primary and secondary light bars) of a diode pump are also made from silicon, and they are under the same power restrictions as the fiber itself. In full-fiber laser systems the diameter of a light bar of a diode pump depends on the diameter of the optical transmission fiber, i.e. its diameter is limited. Furthermore, the shape of the light bars is limited to round.

### SUMMARY OF THE INVENTION

The object of the invention is to solve the problems of the prior art or at least mitigate their drawbacks. The object of the invention is reached by means of the embodiments of the invention.

This invention relates to a novel diode pump, wherein an optical laser pulse beam expander, through which the laser beam is guided forward, is integrated as a part of the diode pump. Preferably, the light bars of the diode pump are made from a material harder than silicon, having a geometric structure capable of sustaining large amounts of power. The inventive diode pump makes it possible to guide a laser beam forward without optical transmission fibers and/or optical high-power connectors that restrict the output power of fiber lasers.

The diode pump according to the invention is characterized in what is set forth in the characterizing part of the independent claim concerning it. The method of manufacturing a diode pump according to the invention is characterized in what is set forth in the characterizing part of the independent claim concerning it. The laser apparatus according to the invention is characterized in what is set forth in the characterizing part of the independent claim concerning it. The method of manufacturing a laser apparatus according to the invention is characterized in what is set forth in the characterizing part of the independent claim concerning it. The heat-machining laser according to the invention is characterized in what is set forth in the characterizing part of the independent claim concerning it. The cold-machining laser according to the invention is characterized in what is set forth in the preamble of the independent claim concerning it.

Other embodiments of the invention are described in the dependent claims. In the diode pump according to the invention, an optical laser pulse beam expander, through which the laser beam is guided forward, is integrated as a part thereof.

In the method of manufacturing a diode pump according to the invention an optical laser pulse beam expander, through which the laser beam is guided forward, is integrated as a part of the diode pump.

The now made invention is based on the surprising observation that a laser beam can be guided forward from a diode pump without a transmission fiber or optical high-power connectors. Such a diode pump has an integrated optical laser pulse beam expander wherefrom the laser beam can be directed to a desired target directly. Because the laser beam is no longer transmitted forward through an optical fiber and optical high-power connectors, the diameter, geometric shape and material of the light bars of the diode pump, and thus the output power of the diode pump, are now independent on the restrictions encompassed by optical fibers and power connectors.

The invention enables very high-power diode pumps that can further be integrated as a part of a laser apparatus where one or more diode-pumped laser beams are guided through an optical laser beam expander integrated with the diode pump directly to a scanner and therefrom to the working point through correcting optics. The now made invention renders it possible to increase the output power of diode pumps significantly by replacing silicon, the current light bar material, with a material having a better resistance to laser pulse powers and, optionally, by doping this material with rare earth metals. The output power of a diode pump can be increased further by changing the geometric shape and diameter of the light bar.

According to an embodiment of the invention a beam expander or reducer is directly integrated with the end of the light bar. This makes it possible to gain installation accuracy advantage in fixed operational geometries. According to an embodiment of the invention it is also possible to integrate another optical beam geometry changer or a fixed correcting optics member with the light bar.

According to an embodiment of the invention the pump has a carbonitride (C₃N₄)- or diamond-based part. According to an embodiment of the invention the beam expander is made from carbonitride and/or has a layer of carbonitride. According to an embodiment of the invention the beam reducer is made from carbonitride and/or has a layer of carbonitride. According to an embodiment of the invention the fixed correcting optics member is made from carbonitride and/or has a layer of carbonitride. According to an embodiment of the invention one of said parts further comprises an optical layer to change the refractive index. According to an embodiment of the invention said layer is the outermost layer of the part.

According to an embodiment of the invention the light bar is based on carbonitride. According to an embodiment of the invention the light bar comprises carbonitride. According to an embodiment of the invention the carbonitride structure of the light bar has been doped to obtain stimulated emission. According to an embodiment of the invention the light bar may have a high operating temperature.

According to an alternative embodiment of the invention, the diodes used for the pumping of a pump according to an embodiment of the invention are replaced and/or complemented with a discharge tube to carry out and/or intensify the pumping for stimulated emission.

A diode pump according to an embodiment of the invention can form part of a vacuum evaporation apparatus and be placed either in- or outside the apparatus. Such a general solution solves the power-restricting problems related to fiber lasers in an advantageous way and, compared with the current situation, enables a practically significant increase of laser power and the delivery thereof to the working point.

According to a first aspect of the invention a number of embodiments can be defined, comprising at least the embodiment according to an embodiment of the invention but adapted to be used in coating and/or deposition type of applications. In this case the material of the target can be evaporated/ablated to be directed as a beam towards the surface of the substrate, whereby the substrate or a derivative thereof forms the product. The method related to the product, the use thereof and/or the use of a precursor for the production of such a product are also considered to fall within the scope of the first aspect of the invention.

According to a second aspect of the invention a number of embodiments can be defined, comprising at least the embodiment according to an embodiment of the invention but adapted to be used in engraving type of applications including also the target piece through-burning embodiments. In this case the material of the target can be evaporated/ablated to be directed as a beam towards the surface of the substrate whereby the target or a derivative thereof forms the product. The method related to the product, the use thereof and/or the use of a precursor for the production of such a product are also considered to fall within the scope of the first aspect of the invention.

According to a third aspect of the invention a number of embodiments can be defined, comprising at least the embodiment according to an embodiment of the invention but as a combination of a first and/or a second aspect, where applicable.

According to an embodiment of the invention the beam expander, reducer and/or the correcting optics member is adapted according to diffractive optics, to divide the path of the beam into branches and/or to focus such a branch, or a part thereof, into a given desired shape for each.

According to an alternative embodiment of the invention the operation of the scanner is replaced with the movement of the radiation source and/or of a part thereof relative to the target in order to deflect the beam on the surface of the target. Thus the target can also be moved, e.g. rotated, to achieve the desired effect.

### FIGURES

The embodiments of the invention will now be explained in more detail by way of example with reference to the figures and the examples related thereto, however without limiting exclusively to the examples described therein. The term “comprise” is used as an open term. The use of similar reference numerals for the parts of the different figures is not intended to restrict the parts exclusively identical, but a person skilled in the art knows that said parts can be dissimilar in different embodiments, where applicable. The embodiments of the invention can be combined, where applicable.

FIG. 1. A diode pump according to the invention as a part of a PDADLS laser system (phased distributed amplified direct-orientation laser system).

FIG. 2 illustrates a part of FIG. 1.

FIG. 3 illustrates a circuit card.

### DETAILED DESCRIPTION OF THE INVENTION

The invention relates to a diode pump wherein an optical laser pulse beam expander, through which the laser beam is guided forward, is integrated as a part of the diode pump. The diode pump can be any diode pump used in laser applications. The optical laser pulse beam expander integrated with the diode pump may consist of one or more parts.

In one preferable embodiment of the invention the light bars of the diode pump are made from a material that is harder than silicon and that has a better resistance to laser pulse power. Such light bars are primary and secondary light bars. Other light bars possibly placeable in a diode pump shall not be excluded from the scope of this invention. Preferable light bar materials harder than silicon are diamond, sapphire, ruby, titanium sapphire and other diamond compounds.

One or more of the light bars of the diode pump may be doped with a rare earth metal or a compound thereof. In one preferred embodiment of the invention this doped light bar is the secondary light bar. Useful rare earth metals are yttrium, erbium, neodynium, ytterbium, thulium or alloys thereof.

In another preferable embodiment of the invention one or more of the light bars of the diode pump is made from silicon. Such a light bar may be doped with a rare earth metal or a compound thereof. Preferably, the light bar is the secondary light bar.

The geometric shape of the light bars may be round. Because the laser beam is no longer guided from the light bar of the diode pump to a fiber, the shape of the fiber does not impose restrictions on the geometric shape of the light bar any longer. Consequently, the shape of the light bar may be something else than round. In one preferred embodiment the shape of the invention the light bar is square or rectangular. The diameter of light bars has previously been dependent on the diameter of the fiber to be connected to the diode pump and on the power resistance of the material. Now the diameter of the light bar can be increased freely. The light bar's resistance to laser pulse power increases at the same time.

The diode pump according to the invention can be provided with integrated diodes and/or separate diodes. Since the fibers and fiber connectors or the material of the light bar do not restrict the output power of the diode pump any longer, the number of integrated and/or separate parts can be increased practically infinitely in order to achieve a desired output power.

In a preferred embodiment of the invention a preamplified laser pulse is delivered into the diode pump, into the rear part of the primary light bar. In another preferable embodiment of the invention the preamplified laser pulse is delivered into the end of the secondary light bar.

The total output power of the diode pump according to the invention can be over 100 W. It can be over 1000 W or 10 000 W. Just as well it can be 100 000 W in certain applications. Preferably, the diode pump according to the invention is made part of a laser apparatus wherein one or more laser beams are guided directly through an optical beam expander integrated with the diode pump to a scanner and therefrom further to the working point through correcting optics.

The working point preferably consists of an evaporable material, and the evaporation is performed preferably in a vacuum. The scanner is preferably a turbine scanner. The diode pump according to the invention preferably forms part of a vacuum evaporation apparatus. The diode pump can be placed in- or outside the vacuum evaporation apparatus. Further, the diode pump can be integrated as a part of the shell structure of the vacuum evaporation apparatus.

The diode pump according to the invention can be used as a part of heat-machining lasers, such as micro- or nanosecond lasers. In another preferable embodiment of the invention the diode pump can be used as a part of cold-machining lasers, such as pico-, femto- and attosecond lasers. In these applications the number of diode pumps may vary between one and infinite.

This invention also relates to a method of manufacturing of a diode pump, in which method an optical laser pulse expander, through which the laser beam is guided forward, is integrated as a part of the diode pump.

The now made invention thus enables novel diode pumps and the manufacture thereof. The laser beam can be transmitted forward from the diode pump without fibers and high-power connectors and the laser beam can be generated at the working point. The absence of fibers and high-power connectors makes it possible to use new, harder, high laser beam power resistant materials as light bar materials. The geometric shape of the light bar is no longer limited to round but the diode pumps may use square, rectangular light bars or light bars shaped in another way, having at least one edge that can be sharp, blunt or rounded, among a number of edges comprising at least one edge. The light bar has then a significantly better ability to receive light. Further, the diameter of the light bar is no longer restricted by the fibers.

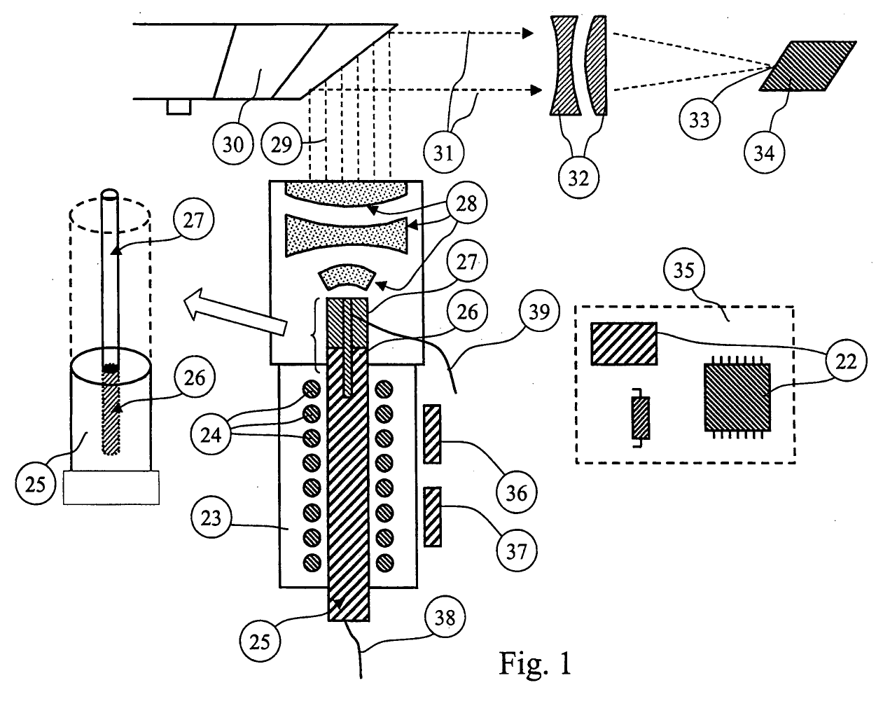

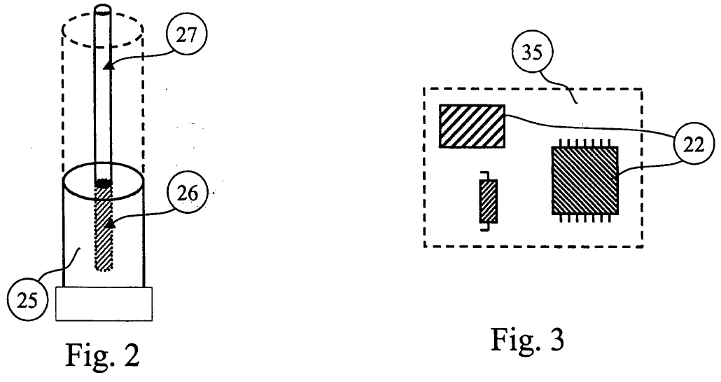

Besides, the primary- (25) and the secondary light pulse (27) can now be in any shape (FIG. 1) because the laser beam thus produced is not led to any optical transmission fiber. Fibers require accurate parameters to keep the laser beam in its form. They place substantial restrictions on the power of the pulse transmitted along the fiber.

The novel diode pump permits the laser pulse any shape and enables the scanning of pulse powers of even 100 MW (megawatts) whereas in the case of the current transmission fibers the pulse power limit is as low as 50 kW.

The elimination of fibers and high-power connectors considerably lowers the price of lasers using diode pumps.

### EXAMPLES

### Example 1

In FIG. 1 a diode pump (23) according to the invention is shown where it is set as a part of a PDAD laser system (phased distributed amplified direct-orientation laser system). An optical laser pulse beam expander (28) is integrated with the structure of the diode pump, whereby a laser beam (29) can be directly directed to a turbine scanner (30) wherefrom the laser beam (31) is guided into a focus point (33) on the surface (34) of a material billet by means of optical focusing lenses (32). A preamplified laser pulse (39) can be delivered either into the rear part (38) of the primary light bar (25), if the secondary light bar (27) extends so far, or then directly into the end of the secondary light bar (27). The secondary light bar as a whole is denoted by numerals (26) and (27). The diodes used in the diode pump are denoted by numeral (24). The fiberlessness of the general solution now makes it possible to choose the diameter and geometric shape of both the primary and the secondary light bar freely. This in turn makes it possible to increase the power gained from the diode pump.

In the diode pump according to the Figure both light bars or only one of the light bars can be doped with a rear earth metal. If a diode pump according to an embodiment of the invention has several light bars, according to an embodiment at least one light bar of them can be doped with a rear earth metal. In an embodiment of the invention none of the light bars is doped with a rear earth metal.

The diode pump (23) can be placed in connection with an electronic circuit card (35) which may include processors (22) or other components. Furthermore, at least the necessary current (39), such as a direct current of 100 V, which is then transformed into a suitable current by means of an appropriate transformer, must be arranged for the circuit card. In an embodiment, the control card may also contain control data and data back to the central unit as well as a preamplified pulse.

FIG. 1 also shows a control signal port for the diode pump (36) and a port for a preamplified laser pulse (37).

1. A diode pump, characterized in that an optical laser pulse beam expander (28), through which a laser beam is guided forward from the diode pump, is integrated as a part of the diode pump.

2. A diode pump as defined in claim 1, characterized in that the light bars of the diode pump are made from a material that is harder than silicon and that has a better resistance to laser pulse power than silicon.

3. A diode pump as defined in claim 1, characterized in that the light bars of the diode pump are made from diamond, sapphire, ruby or titanium sapphire.

4. A diode pump as defined in claim 1, characterized in that one or more of the light bars of the diode pump are doped with a rare earth metal or a compound thereof.

5. A diode pump as defined in claim 4, characterized in that said rare earth metal is yttrium, erbium, neodynium, ytterbium, thulium or an alloy of these.

6. A diode pump as defined in claim 1, characterized in that one or more of the light bars of the diode pump comprises silicon.

7. A diode pump as defined in claim 1, characterized in that one or more of the light bars of the diode pump is doped with a rare earth metal or a compound thereof.

8. A diode pump as defined in claim 1, characterized in that the light bars of the diode pump are round.

9. A diode pump as defined in claim 1, characterized in that the light bars of the diode pump are edged in shape so that they comprise a number of edges, whereby the edges are sharp, blunt and/or rounded and this number of edges comprises at least one edge per light bar.

10. A diode pump as defined in claim 9, characterized in that said light bar is square or rectangular in shape.

11. A diode pump as defined in claim 1, characterized in that the diode pump is provided with integrated diodes.

12. A diode pump as defined in claim 1, characterized in that the diode pump is provided with separate power diodes.

13. A diode pump as defined in claim 1, characterized in that a preamplified laser pulse is delivered into the diode pump, into the rear part of the primary light bar.

14. A diode pump as defined in claim 1, characterized in that a preamplified laser pulse is delivered directly into the end of the secondary light bar.

15. A diode pump as defined in claim 1, characterized in that its total output power is over 100 W.

16. A diode pump as defined in claim 1, characterized in that its total output power is over 1000 W.

17. A diode pump as defined in claim 1, characterized in that its total output power is over 10000 W.

18. A diode pump as defined in claim 1, characterized in that its total output power is over 100 000 W.

19. A laser apparatus, characterized in that it has a diode pump according to claim 1.

20. A laser apparatus as defined in claim 19, characterized in that it has one or more diode-pumped laser beams arranged to be guided directly through an optical beam expander integrated with the diode pump to a scanner and therefrom through correcting optics to the working point.

21. A laser apparatus as defined in claim 19, characterized in that the diode pump forms part of a vacuum evaporation apparatus.

22. A laser apparatus as defined in claim 19, characterized in that it has the diode pump placed inside the vacuum evaporation apparatus.

23. A laser apparatus as defined in claim 19, characterized in that it has the diode pump placed outside the vacuum evaporation apparatus.

24. A heat-machining laser, characterized in that it has a diode pump according to claim 1 arranged optimized for a micro- or nanosecond laser.

25. A cold-machining laser, characterized in that it has a diode pump according to claim 1 arranged optimized for a pico-, femto- and/or attosecond laser.

26. A method of manufacturing a diode pump, characterized in that in the method an optical laser pulse expander (28), through which a laser beam is guided forward from the diode pump, is integrated as a part of the diode pump.

27. A method as defined in claim 26, characterized in that in the method a material harder than silicon is used as the material of the light bars of the diode pump.

28. A method as defined in claim 26, characterized in that in the method diamond, sapphire, ruby or titanium sapphire is used as the material of the light bars of the diode pump.

29. A method as defined in claim 26, characterized in that in the method one or more of the light bars of the diode pump are doped with a rare earth metal or a compound thereof.

30. A method as defined in claim 29, characterized in that in the method the rare earth metal is yttrium, erbium, neodynium, ytterbium, thulium or an alloy thereof.

31. A method as defined in claim 26, characterized in that in the in the method silicon is used as the material of the light bars of the diode pump.

32. A method as defined in claim 26, characterized in that in the method one or more of the light bars of the diode pump is doped with a rare earth metal or a compound thereof.

33. A method as defined in claim 26, characterized in that in the method the light bars of the diode pump are made round.

34. A method as defined in claim 26, characterized in that in the method the light bars of the diode pump are made edged in shape so that they have a number of edges, whereby the edges are sharp, blunt and/or rounded, and this number of edges has at least one edge per light bar.

35. A method as defined in claim 34, characterized in that in the method the light bar shape is square or rectangular.

36. A method as defined in claim 26, characterized in that in the method the diode pump is provided with integrated circuits.

37. A method as defined in claim 26, characterized in that in the method the diode pump is provided with separate diodes.

38. A method as defined in claim 26, characterized in that in the method the structure of the diode pump makes it possible to deliver a preamplified laser pulse into the diode pump, into the rear part of the primary light bar.

39. A method as defined in claim 26, characterized in that in the method the structure of the diode pump makes it possible to deliver a preamplified laser pulse into the end of the secondary light bar.

40. A method as defined in claim 26, characterized in that the output power of a diode pump made using the method is over 100 W.

41. A method as defined in claim 26, characterized in that the output power of a diode pump made using the method is over 1000 W.

42. A method as defined in claim 26, characterized in that the output power of a diode pump made using the method is over 10000 W.

43. A method as defined in claim 26, characterized in that the output power of a diode pump made using the method is over 100 000 W.

44. A method of manufacturing a laser apparatus, characterized in that it comprises the stage according to claim 26 for manufacturing a diode pump.

45. A method as defined in claim 44, characterized in that therein one and/or more diode pumps is arranged as a part of the laser apparatus and a diode-pumped laser beam is arranged to be guided from each diode pump, directly through an optical beam expander integrated with the diode pump, to the working point along an optical path.

46. A method as defined in claim 45, characterized in that in the method a scanner and/or correcting optics is installed in the optical path.

47. A method as defined in claim 44, characterized in that in the method the diode pump can be installed as a part of a vacuum evaporation apparatus.

48. A method as defined in claim 44, characterized in that in the method the diode pump can be arranged inside the vacuum evaporation apparatus.

49. A method as defined in claim 44, characterized in that in the method the diode pump can be arranged outside the vacuum evaporation apparatus.

50. Heat-machining laser, characterized in that it has a diode pump manufactured using the method according to claim 26, whereby the heat-machining laser is a micro- or nanosecond laser or a part of one like that.

51. Cold-machining laser, characterized in that it has a diode pump manufactured using the method according to claim 26, whereby the cold-machining laser is a pico-, femto- or attosecond laser or a part of one like that.
